(19) United States
(12) Patent Application Publication
(10) Pub. No.: US 2026/0354433 A1
(43) Pub. Date: Nov. 12, 2026

(54) High acid and high protein nutritional beverage and method of making

(71) Applicant: VidaFuel, Inc., Greenwich, CT (US)

(72) Inventors: Bette Parolini, Nashville, TN (US); Matthew J. Wiant, Fairfield, CT (US); Steven J. Leusner, West Kingston, RI (US)

(21) Appl. No.: 19/559,394

(22) Filed: Mar. 6, 2026

Related U.S. Application Data
(60) Provisional application No. 63/800,864, filed on May 6, 2025.

(51) Int. Cl. A23L 33/18; A23J 3/08; A23L 2/38; A23L 2/56; A23L 2/60; A23L 2/66; A23L 2/68; A23L 33/19

(52) U.S. Cl. CPC A23L 33/18; A23J 3/08; A23L 2/38; A23L 2/56; A23L 2/60; A23L 2/66; A23L 2/68; A23L 33/19

(57) ABSTRACT

Ready-to-drink, high acid and high protein nutritional beverages having a low viscosity are described. Also described are methods for making high acid and high protein nutritional beverages with a low viscosity, as well as methods of supplementing the nutritional requirements of individuals in need thereof.

### RELATED APPLICATION

This application claims the benefit of U.S. Provisional Application No. 63/800,864, filed on May 6, 2025. The entire teachings of the above application are incorporated herein by reference.

### BACKGROUND

Consumer desire for high protein beverages and products drives innovation of new formulations with this objective. However, there are technical difficulties with adding high concentrations of proteins in beverage formulations that are barriers to achieving higher protein concentrations beyond currently available products. Protein content of 10 grams to 20 grams in a 10 oz to 16 oz single serving are typical, with protein concentrations up to 11% in solution disclosed in the literature.

There is a need for nutritional beverages that provide even higher protein concentrations in small serving sizes.

### SUMMARY

The disclosure solves the problem of achieving high protein levels in nutritional beverages and overcomes previous limitations in process technology by using a unique set of ingredients, formulated in a unique process which produces a low viscosity beverage despite its high protein content. The unique processing technology of the disclosure allows for the production of nutritional beverages comprising a high concentration of at least two different proteins which were previously difficult to incorporate in high concentrations in solution without the protein(s) clumping, gelling and/or becoming a solid or high viscosity liquid form that can no longer be consumed as a beverage.

In one aspect, ready-to-drink, high acid and high protein nutritional beverages having a low viscosity are described. The nutritional beverages of the disclosure are high acid solutions comprising water and a combination of at least two different proteins, where the total protein content is present in high concentrations. In embodiments, the first protein is the base of the formulation and is any milk protein form, such as whey protein and combinations of whey protein forms. In other embodiments, the combination of the at least two different proteins are whey protein as a first protein, and collagen or other protein as the at least second protein. The pH of the high acid solution is from about 2.5 to about 5.5. The combination of the at least two different proteins is added to the solution to achieve a total protein concentration of from about 15% by weight to about 50% by weight. The high acid solution should have a viscosity below about 300 cps and a texture that is non-gelling and can be consumed as a nutritional beverage. In embodiments, the serving size of the nutritional beverage will be from about 1.0 oz to about 6.0 oz (about 26.57 ml to about 177.44 ml), as a ready-to-drink beverage, for example, in a single-serving package size or in multi-serving package formats. In embodiments, the formulation will have a smooth texture that is non-gelling.

In another aspect, the disclosure pertains to methods of making the high acid and high protein nutritional beverages that uniquely possess high protein concentrations from at least two proteins or protein sources. In one embodiment of this aspect, methods are disclosed to achieve up to 30% by weight of a first protein source as the base of the formulation (e.g., any whey protein) and a second protein in a high acid and high protein nutritional beverage having a viscosity that is flowable and drinkable. In other embodiments of this aspect, methods are disclosed to combine at least two proteins sources together at high concentrations up to 50% by weight in an aqueous solution, and then further process the combined proteins into nutritional beverage formulations that have the viscosity of a drinkable formulation that does not gel.

In yet another aspect, the disclosure pertains to uses of the nutritional beverages of the disclosure for providing nutritional benefits and supplementation to individuals in need thereof. In embodiments of this aspect, the nutritional beverage can be consumed for maintaining health and nutrition; improving nutritional needs in the case of illness, aging, disease recovery or surgical recovery; improving energy and performance, for examples, in athletes, or in individuals with protein deficiency. The high protein concentration formulations can be packaged in ready-to drink sizes for a wide variety of individual uses, depending on the needs of the individual and condition to be treated or supplemented.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 illustrates an example embodiment of a flowable nutritional beverage comprising whey protein isolate and hydrolyzed bovine collagen in acidic solution at pH about 4.2 and viscosity of 65 cps, made according to the methods of the disclosure when the proteins are added to an acidic solution creating a protein beverage with 20% by weight protein.

FIG. 2 illustrates an example embodiment of an agglomerated mixture of whey protein isolate and hydrolyzed bovine collagen (20% by weight total protein), prepared according to the same process as FIG. 1, but without the use of an acidic solution. The result is a solid rather than a consumable fluid.

FIG. 3 illustrates an example embodiment of an agglomerated mixture of whey protein isolate and hydrolyzed bovine collagen (20% by weight total protein), prepared according to the same process as FIG. 1, but the proteins were added to water without acid and mixed together. The acid was then added. The resulting viscosity was over 300 cps.

FIG. 4 illustrates an example embodiment of a flowable nutritional beverage comprising 15% by weight whey protein isolate and 20% by weight hydrolyzed bovine collagen (35% total protein) in acidic solution at pH about 4.7 and viscosity of 170 cps, made according to the methods of the disclosure when the proteins are added to an acidic solution.

FIG. 5 illustrates an example embodiment of a flowable nutritional beverage comprising 20% by weight whey protein isolate and 30% by weight hydrolyzed bovine collagen in acidic solution at pH about 4.8 and viscosity of 275 cps, made according to the methods of the disclosure when the proteins are added to an acidic solution.

FIG. 6A illustrates an example embodiment of an agglomerated mixture of whey protein isolate (20% by weight total protein), prepared in an acidic solution according to the methods of Example 1. The result is a solid rather than a consumable fluid.

FIG. 6B illustrates an example embodiment of a flowable nutritional beverage comprising 20% by weight whey protein isolate and 1% by weight hydrolyzed bovine collagen in acidic solution.

### DETAILED DESCRIPTION

A description of example embodiments follows.

### Nutritional Beverages

In a first aspect of the disclosure, ready-to-drink, high acid and high protein nutritional beverages (“the nutritional beverage(s)”) having a low viscosity that are suitable for consumption as a flowable beverage are described. The nutritional beverage of the disclosure is a high acid solution comprising water and a high concentration of a combination of at least two different proteins (referred to herein as first protein and at least a second protein when discussing the formulation in general). The high acid and high protein nutritional formulation has a viscosity below about 300 cps and a texture that is non-gelling and can be consumed as a nutritional beverage. In embodiments, the formulation will have a smooth texture that is non-gelling.

Proteins suitable for incorporation into the nutritional beverage can be selected based on the protein's amino acid profile, depending upon the intended purpose and use of the nutritional beverage. The nutritional beverages of the disclosure comprise a high concentration of a combination of at least two different proteins.

Protein sources in addition to or alternative to milk proteins such as whey protein include, but are not limited to, casein protein sources, other animal-based proteins such as collagen, plant-based protein sources including, soy protein, pea protein, rice protein, faba bean protein, hemp protein, chia protein.

In a first embodiment, a combination of at least two different proteins may be desirable to provide protein sources that result in a desired total amino acid profile in the formulation. As stated, selection of the protein combination will depend upon the desired amino acid profile for the resultant formulation, based on nutritional needs of the end-user. Accordingly, a ready-to-drink, high acid and high protein nutritional beverage having a low viscosity is described, comprising: a high acid solution comprising water and a combination of at least two different proteins, wherein the high acid solution has a pH of from about 2.5 to about 5.5. The combination of the at least two protein sources is from about 15% by weight to about 50% by weight in the high acid solution. The high acid solution will have a viscosity below about 300 cps and a texture that is non-gelling and can be consumed as a nutritional beverage. In embodiments, the formulation will have a smooth texture that is non-gelling.

In embodiments, the combination of proteins is whey and collagen. The whey protein can be selected from whey protein isolate, whey protein concentrate, whey protein hydrolysate or combination thereof. In embodiments, the any of these aforementioned whey protein forms and combinations can be lecithinated and/or instantized.

In other embodiments, the second protein is collagen or collagen peptides. In some embodiments, the collagen is hydrolyzed collagen which is also known as gelatin. For purposes of this disclosure, any type of collagen (e.g., Type I, Type II, Type III, or any combination of these) from any source (fish, marine, meat, such as chicken, pig and beef, or any combination of these) can used in the nutritional beverage herein and selection of the collagen type will depend on the desired amino acid profile selected for the intended end use of the formulation. The flavor profile of the nutritional beverage will change depending upon the source of the collagen. In embodiments, the collagen will be beef collagen.

Whatever protein combination is selected for the formulation, the proportions of the proteins incorporated into the nutritional formulation will depend on each protein's amino acid profile, solubility, concentration, taste and textural properties.

The protein concentration (e.g., combination of different proteins) of the nutritional beverage can be from about 15% by weight to about 50% by weight, while still maintaining a viscosity that is flowable and drinkable. In embodiments, the protein concentration of the final formulation can be selected from any of the following percentages or defined by any ranges within the following percentages: about 15% by weight, about 16% by weight, about 17% by weight, about 18% by weight, about 19% by weight, about 20% by weight, about 21% by weight, about 22% by weight, about 23% by weight, about 24% by weight, about 25% by weight, about 26% by weight, about 27% by weight, about 28% by weight, about 29% by weight, about 30% by weight, about 31% by weight, about 32% by weight, about 33% by weight, about 34% by weight, about 35% by weight, about 36% by weight, about 37% by weight, about 38% by weight, about 39% by weight, about 40% by weight, about 41% by weight, about 42% by weight, about 43% by weight, about 44% by weight, about 45% by weight, about 46% by weight, about 47% by weight, about 48% by weight, about 49% by weight, about 50% by weight. In other embodiments, the protein concentration of the nutritional beverage can be from about 20% by weight to about 35% by weight. In yet other embodiments, the protein concentration of the nutritional beverage can be from about 25% by weight to about 30% by weight.

When the protein combination is whey protein and collagen protein, the concentration of whey protein is from about 1% by weight to about 99% by weight. In an embodiment, the concentration of whey protein is from about 12% by weight to about 50% by weight. In another embodiment, the concentration of whey protein is from about 15% by weight to about 35% by weight. The collagen will then be present in the formulation as the weight percentage balance with the whey protein to arrive at a total protein concentration of about 15% by weight to about 50% by weight in the nutritional beverage. In one embodiment, the concentration of collagen in the formulation will be from about 1% by weight to about 99% by weight. In an embodiment, the concentration of collagen protein is from about 50% by weight to about 88% by weight. In another embodiment, the concentration of collagen protein is from about 65% by weight to about 85% by weight. In yet another embodiment, the concentration of collagen protein is from about 10% by weight to about 99% by weight.

In other aspects, the amount of a second protein, such as collagen, is present in the protein combination in amounts as low as from about 1% by weight. It has been shown that acid containing formulations comprising a high protein content of whey protein alone are flowable but form an irreversible gel during the heating and sterilization stage of the process of the disclosure. Surprisingly, this gel formation can be disrupted when collagen is added to a high concentration whey formulation before the heating and sterilization steps. This disruption can occur by the addition of even small amounts of collagen. It has been demonstrated herein that high concentrations of whey protein as the base in a flowable and drinkable formulation can be achieved by acidifying the solution before the whey protein is added to the solution and then disrupting the whey protein's ability to form gels with a second protein (e.g., collagen).

An objective of the nutritional beverage of the disclosure is to provide a ready-to drink formulation having a high protein concentration per single serving, such as provided in a single serving package or a multi-serving package where each serving provides a high concentration of protein, where the protein concentration is as described herein. In embodiments, a serving size of the nutritional beverage will be from about 1.0 oz to about 6.0 oz (about 26.57 ml to about 177.44 ml), as a ready-to-drink beverage, for example, in a single-serving package size or in multi-serving package format. In other embodiments, the serving size will be about 1.0 oz (about 26.57 ml) to about 6.0 oz (about 177.44 ml). In some embodiments, the nutritional beverage is provided in a ready-to-drink package in an amount of about 2 ounces (about 59.15 ml) to about 3 ounces (about 88.72 ml). In yet other embodiments, the serving size of the nutritional beverage can be selected from any of the following amounts or defined by any ranges within the following amounts: about 1.0 oz (about 26.57 ml), 2.0 oz (about 59.15 ml), about 3 ounces (about 88.72 ml), about 4.0 oz (about 118.29 ml), about 5.0 oz (about 147.87 ml), about 6.0 oz (about 177.44 ml).

A ready-to-drink single serving of the nutritional beverage will provide from about 4.4 grams protein (about 15% by weight) to about 14.75 grams of protein (about 50% by weight) per ounce (about 59.15 ml) of the nutritional beverage. The total grams of protein in a single serving ready-to-drink package of the nutritional beverage can be from about 9 grams to about 88.5 grams of protein. In an embodiment, the total grams of protein in a single serving ready-to-drink package of the nutritional beverage can be from about 16 grams to about 20 grams of protein. In another embodiment, the total grams of protein in a single serving ready-to drink package of the nutritional beverage can be selected from any of the following amounts or defined by any ranges within the following amounts: about 9 grams, about 10 grams, about 11 grams, about 12 grams, about 13 grams, about 14 grams, about 15 grams, about 16 grams, about 17 grams, about 18 grams, about 19 grams, about 20 grams, about 21 grams, about 22 grams, about 23 grams, about 24 grams, about 25 grams, about 26 grams, about 27 grams, about 28 grams, about 29 grams, about 30 grams, about 31 grams, about 32 grams, about 33 grams, about 34 grams, about 35 grams, about 36 grams, about 37 grams, about 38 grams, about 39 grams, about 40 grams, about 41 grams, about 42 grams, about 43 grams, about 44 grams, about 45 grams, about 46 grams, about 47 grams, about 48 grams, about 49 grams, about 50 grams, about 51 grams, about 52 grams, about 53 grams, about 54 grams, about 55 grams, about 56 grams, about 57 grams, about 58 grams, about 59 grams, about 60 grams, about 61 grams, about 62 grams, about 63 grams, about 64 grams, about 65 grams, about 66 grams, about 67 grams, about 68 grams, about 69 grams, about 70 grams, about 71 grams, about 72 grams, about 73 grams, about 74 grams, about 75 grams, about 76 grams, about 77 grams, about 78 grams, about 79 grams, about 80 grams, about 81 grams, about 82 grams, about 83 grams, about 84 grams, about 85 grams, about 86 grams, about 87 grams, about 88 grams, about 88.5 grams.

Multi-serving packages of the nutritional beverage of the disclosure are contemplated. It should be appreciated that the multi-serving packaging will be determined by the manufacturer based on manufacturer and customer preferences and needs.

High protein concentrations can be achieved in the nutritional beverages of the disclosure by controlling the pH of the formulation, controlling the degree of gelling of the whey protein and controlling the viscosity so that the final formulation is flowable and drinkable. The pH of the nutritional beverage should be from about 2.5 to about 5.5. In embodiments, the pH of the nutritional beverage is about 4.0 to about 4.6. In this pH range, the nutritional beverage is considered to be a high-acid beverage under the USDA definition for high-acid products. The benefits of an acidic environment will be discussed in detail in the methods of making the nutritional beverage section of the disclosure.

The viscosity of the nutritional beverage is important in achieving a product that is flowable and drinkable. The end-product viscosity should be below about 300 cps. In embodiments, the viscosity should be below about 250 cps, below about 225 cps, below about 200 cps, below about 175 cps, below about 150 cps, below about 125 cps, below about 100 cps. In other embodiments, the viscosity can be selected from the following: from about 25 cps to about 300 cps, from about 25 cps to about 275 cps, from about 25 cps to about 250 cps, from about 25 cps to about 225 cps, from about 25 cps to about 200 cps, from about 25 cps to about 175 cps; from about 25 cps to about 150 cps. In yet other embodiments, the viscosity is from about 40 cps to about 150 cps. In other embodiments, the viscosity is from about 40 cps to about 100 cps. It should be understood that the desired viscosity of the nutritional beverage will be determined by the manufacturer based on manufacturer, and customer preferences and needs. In one embodiment, the viscosity is suitable for oral consumption. In another embodiment, the viscosity is suitable for a feeding tube.

Depending upon the intended use of the nutritional beverage, it may be desirable to augment the formulation with additional amino acids not provided by the combination of the at least two different proteins (e.g., the first protein and second protein) in the formulation. It may also be desirable to boost the level of selected amino acids in the combination of the at least two different proteins with one of the amino acids that are present in the protein(s) of the formulation, as needed for a specific intended use. In embodiments, the nutritional beverages of the disclosure can be supplemented with one or more amino acids other than the amino acids provided by the whey protein and collagen. For example, the nutritional beverage comprising the combination of whey protein and collogen can be supplemented with amino acids selected from but not limited to arginine, glutamine, hydroxymethylbutyrate (HMB), or combinations of these. In another embodiment, the levels of amino acids provided by the whey protein and collagen can be augmented by the addition of one or more amino acids that are naturally present in whey protein and collagen. Augmentation may desirable when the natural amino acid levels are not at the levels for appropriate nutritional supplementation based on intended use.

Other ingredients can be incorporated into the nutritional beverage such as, but not limited to, emulsifiers, flavoring agents, sweetening agents, preservatives, vitamins, minerals, soluble fiber, pro-biotics, polyphenols, plant extracts.

Suitable sweetening agents include, but are not limited to, sucrose, fructose, glucose, lactose, maltose, galactose, arabinose, natural sugars, sugar alcohols, artificial sweeteners, naturally derived low-calorie sweeteners, rare sugars, and fibers. Sugar alcohols (e.g., polyols) include but are not limited to erythritol, xylitol, sorbitol, maltitol, mannitol, isomalt, inositol and lactitol. Sugar substitutes from artificial or natural sources include but are not limited to, saccharin, aspartame, acesulfame potassium (Ace-K), sucralose, neotame, advantame trehalose, isomaltulose, and plant derived sweeteners, such as but not limited to Stevia and its derivatives (such as but not limited to Rebaudioside A (Reb A), stevioside, steviol glycosides, Stevia extract, Stevia leaf extract, Rebaudioside M (Reb M)), monk fruit. These are typically known as high intensity sweeteners. Rare sugars include but are not limited to Allulose (D-psicose), D-allulose, D-Tagatose, L-Sorbose, Allose, Apiose. Sugar sources include, but are not limited to, sugar cane, beet, brown sugar, agave, barley malt syrup, barley sugar, carob, coconut, corn, palm, maple, rice, sorghum.

Flavors and flavoring agents suitable for use in the nutritional beverage include, but are not limited to, any fruit flavor, chocolate, vanilla, mocha, coffee, matcha, combinations thereof and flavor blends. Examples of fruit flavors include, but are not limited to, apple, grape, cranberry, pomegranate, pear, peach, pineapple, cherry, melon (watermelon, cantaloupe), plum, kiwi, mango, banana, papaya, apricot, acai, fig, citrus fruits including but not limited to lemon, orange, tangerine, grapefruit and lime; and berries including, but not limited to, strawberry, blackberry, boysenberry, raspberry, blueberry, currants. In preferred embodiments, the colors and flavors should be from all-natural sources. In some embodiments, the flavor or flavoring agents comes from spices and/or nuts such as, but not limited to, turmeric, cinnamon, pepper, cardamom, nutmeg, clove, allspice, five spice, anise, rosemary, sage, thyme, pumpkin spice, almonds, pistachio, cashew, hazelnut, walnut, peanut, pecan, any combinations of these and extracts of these.

The nutritional beverage can further comprise at least one preservative selected from sodium benzoate, potassium sorbate and combinations thereof. The preservative can provide antimicrobial properties. For examples, cultured dextrose products and other natural antimicrobial agents can be incorporated into the nutritional beverages of the disclosure.

The nutritional beverages are storage stable, pasteurized and read-to drink.

### Methods of Making the Nutritional Beverages

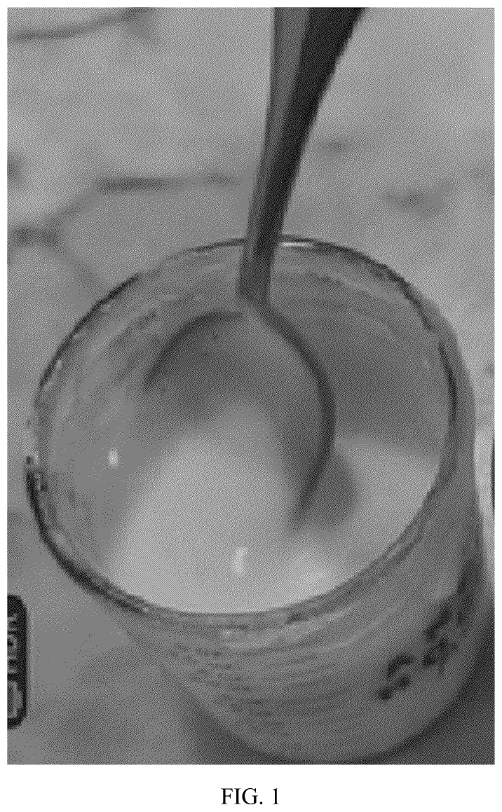

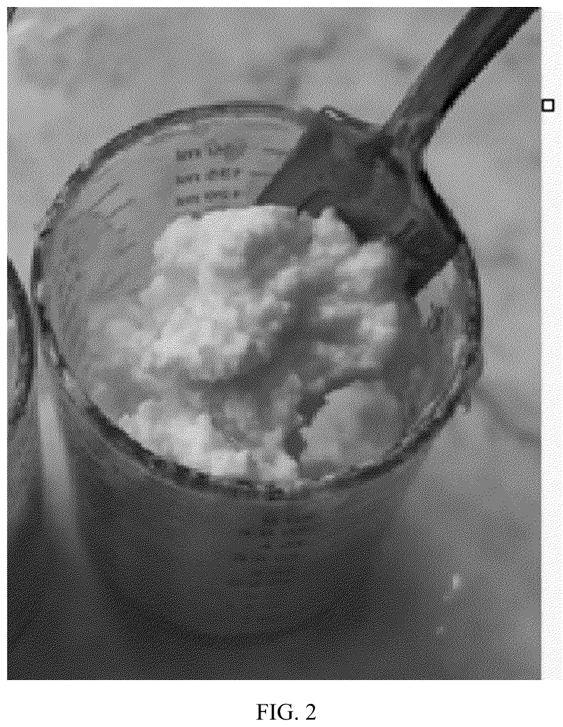

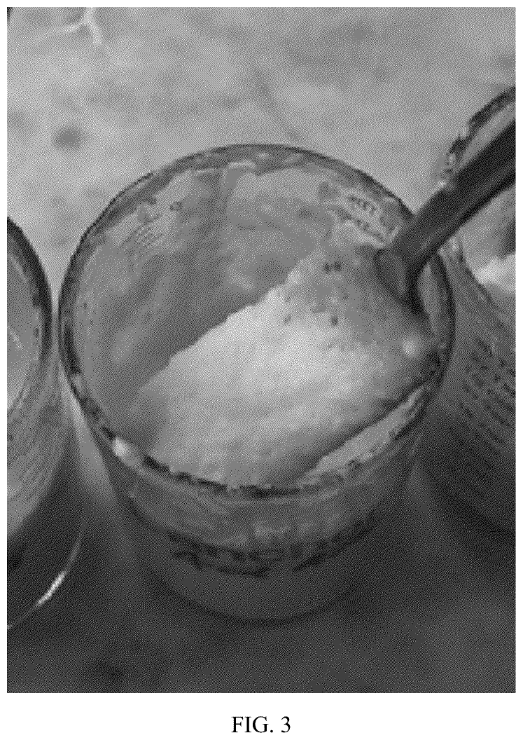

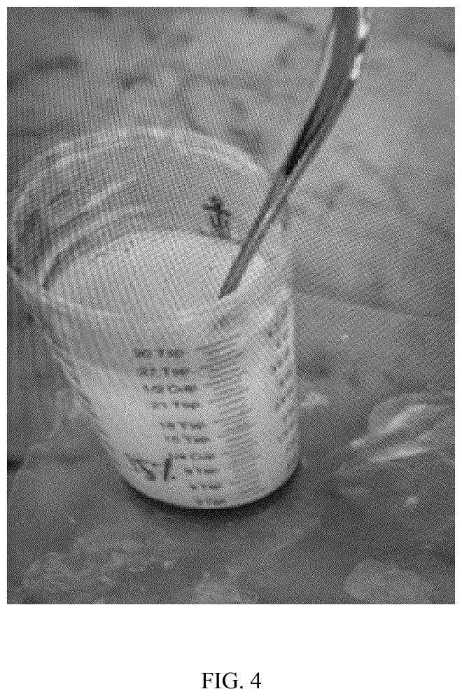

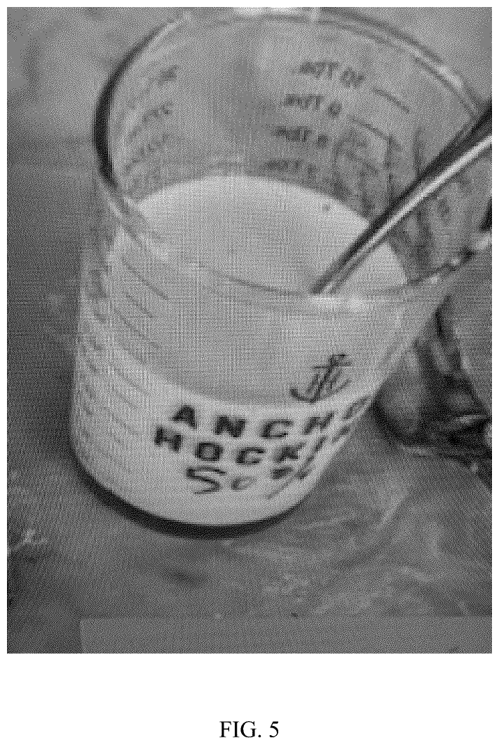

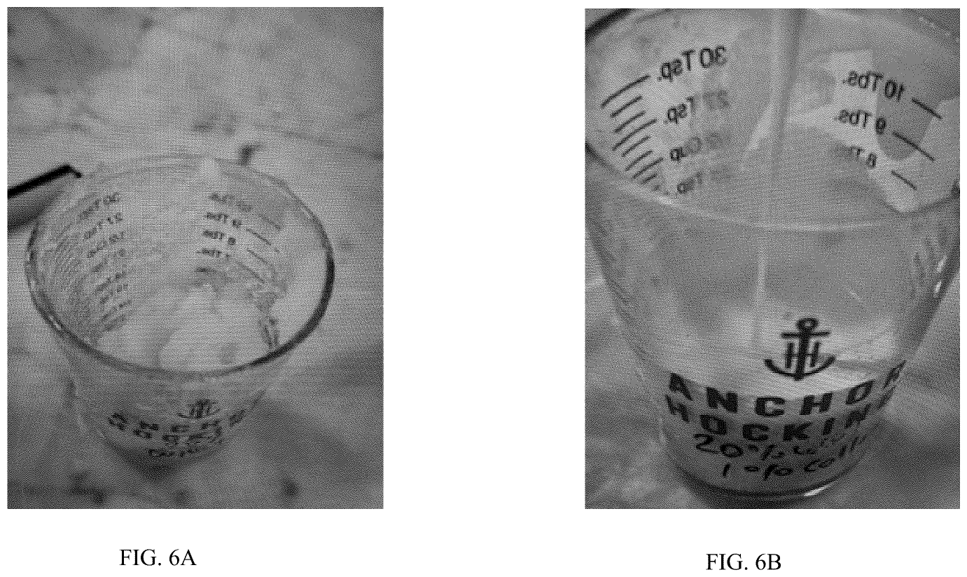

In a first aspect, the disclosure pertains to methods for making a high acid and high protein nutritional beverage with a low viscosity that is flowable, drinkable and has a texture that is non-gelling (e.g., smooth texture). Details of the nutritional beverages, as described above, also pertain to the nutritional beverages made by the methods described in this section. The methods disclosed herein solve the problem of combining into solution a combination of a least two different proteins that were previously difficult to combined in high concentrations without the protein or combination of proteins from clumping, gelling and/or becoming a solid form or high viscosity liquid form that can no longer be consumed as a beverage. The methods of the disclosure control the building of viscosity during the addition of a high concentration of a combination of the at least two different proteins into solution and during the processing steps to produce the nutritional beverage. Control of viscosity and retaining the flowable character of the solution throughout the process are remarkable achievements under the high concentrations of a combination of proteins incorporated into the beverage. Comparative examples of high concentration solutions that were not processed according to the disclosure resulted in high viscosity agglomerated mixtures that were no longer flowable and drinkable. FIGS. 2 and 3 illustrate high viscosity, high protein products prepared as admixtures, compared to counterpart high concentration protein combinations prepared according to the methods of the disclosure. In contrast, FIG. 1, FIG. 4 and FIG. 5 illustrate formulations made by the methods of the disclosure in a flowable and drinkable viscosity. FIG. 6A shows a high viscosity agglomerated formulation of whey protein in acid solution, produced in the absence of collagen. In comparison, FIG. 6B illustrates a formulation having a high whey protein content in a flowable and drinkable formulation using a second protein in an acid solution, in this case 1% by weight collagen, to prevent the formation of a whey protein gel.

According to the first aspect, the method of making a high acid and high protein nutritional beverage comprises preparing a solution comprising water, food-grade acid in an amount sufficient to adjust the pH of the solution to under about 5.5, and an optional sweetening agent. The solution can be prepared at room temperature or heated to a temperature sufficient to solubilize the food-grade acid and optional sweetening agent.

Suitable food-grade acids include but are not limited to phosphoric acid, sodium acid sulfate, citric acid, tartaric acid, lactic acid, fumaric acid, malic acid, acetic acid, ascorbic acid, folic acid, and other food-grade organic acids that would be known to the skilled person for the purpose of adjusting the pH. In an embodiment, the acid is citric acid, malic acid, phosphoric acid and combinations thereof. In another embodiment, the pH reducing food-grade acid is phosphoric acid. The concentration of food grade acid added to the solution to achieve the target pH can be readily ascertained by the skilled person.

In embodiments, the first protein and the second or subsequent protein can include, but are not limited to, milk proteins such as whey protein, casein protein sources, other animal-based proteins such as collagen, plant-based protein sources including, soy protein, pea protein, rice protein, faba bean protein, hemp protein, chia protein.

For embodiments comprising whey protein as the first protein in combination with at least one other protein, such as collagen, it is preferred for the whey protein to be incorporated into the acidic solution first. Whey can be added into the acidic solution, at room temperature or elevated temperature depending upon which conditions were used to prepare the acidic solution. In other words, it is not necessary to change the temperature of the acidic solution before the whey is added.

After the first protein has been added, shear is applied to the first protein and acid solution at a speed that can incorporate the first protein adequately into the solution but will minimize or prevent formation of lumps of the protein. For example, when whey protein is the first protein added to solution, it is necessary to apply shear to incorporate the whey protein into the solution. Whey protein has a tendency to aggregate and lump in solution so a balance of shear speed should be employed to prevent this tendency. Preventing or reducing the formation of protein lumps or aggregates is important during incorporation of the whey protein in solution. Shear is applied for a period of time sufficient for the protein (e.g., whey protein) to become incorporated into the solution.

The shear conditions can be reduced to the minimum necessary to incorporate the additional protein into the solution. The second protein (e.g., collagen) is added to the acid solution comprising the first protein (e.g., whey protein) and mixed under the reduced shear conditions to disperse the second protein and reduce or minimize formation of foam. The solution is mixed for a period of time sufficient to incorporate the second protein (e.g., collagen) into the solution and to then allow the acid to interact with the proteins. Again, it is not necessary to change the temperature of the solution for this step in the process. Room temperature or elevated temperature can be utilized. In embodiments, the shear conditions used to combine the first protein into the acidic solution can be maintained for the addition of the second or subsequent protein.

For production of nutritional formulations comprising more than two different proteins, the third and subsequent proteins get added sequentially to the solution in the same manner as the second protein. Alternatively, the third and subsequent proteins can be added to the acid solution concurrently with the second protein and preferably should be added before the pH adjustment. In embodiments, when the formulations are boosted or augmented with amino acids, the amino acids should be added to the formulation before the final pH adjustment.

After all of the intended proteins have been incorporated, the pH of the solution should be measured and, if needed, adjusted to below about 5.5 to produce a high acid and high protein solution. In embodiments, the pH of the solution should be from about 2.5 to about 5.5. In other embodiments, the pH of the solution should be adjusted to below about 4.6. In yet other embodiments, the pH of the solution should be adjusted to about 4.0 to about 4.6. The acid can be the same food-grade acid used at the beginning of the process, or it can be a different food-grade acid from the listing of acids provided above. In an embodiment, the pH reducing food-grade acid is phosphoric acid.

For embodiments where the nutritional beverage comprises whey protein, the high acid and high concentration protein solution at the target pH is then heated to a temperature above the gelling temperature of the whey protein for a period of time to cause the whey protein to gel. The gelling temperature of whey protein is typically above 78 °C (172 °F), but the skilled person will readily recognize the appropriate temperature to apply to cause the whey protein to gel. The solution is then subjected to shear conditions, such as achieved by homogenization or high shear mixing, that are sufficient to break the gel that has formed in the heated solution. The resulting high acid and high protein solution is pasteurized for a period of time to achieve microbial stability. The pasteurized solution is cooled and package in aseptic containers as a ready-to-drink nutrition beverage.

When optional ingredients, as discussed in the previous section, are to be included into the formulation, the time to add optional ingredients during the process may be important.

The addition of at least one sweetening agent should be added at the beginning when the acid solution is made and before the proteins are added to the acid solution. The addition of flavors, flavoring agents, preservatives, soluble fibers, minerals, vitamins, pro-biotics, polyphenols, plant extracts should be added after the proteins have been added.

It may be desirable to control foam formation or reduce foam production during the addition of the proteins. Accordingly, the process above can further comprise adding an anti-foaming agent (food-grade) to the solution before or after the addition of protein. Suitable food-grade anti-foaming agents (also referred to as defoamer) are known.

In an example method of the disclosure, high acid nutritional beverage with a high concentration of whey protein with a low viscosity are produced by a process, comprising:
a) preparing a solution comprising water, food-grade acid in an amount to adjust the pH of the solution to under about 5.5, and optional sweetening agent;
b) adding whey protein into the solution and applying shear to the solution for a sufficient period of time to reduce or minimize formation of whey protein lumps and to incorporate the whey protein into the solution;
c) adding a different protein into the solution of b) under the reduced shear conditions to reduce or minimize formation of lumps for a period of time sufficient to incorporate the different protein into the solution;
d) adjusting the pH of the solution with a pH reducing food-grade acid to a pH below about 5.5 to produce a high acid and high protein solution;
e) heating the high acid and high protein solution above gelling temperature of the whey protein to gel the whey protein and then applying shear sufficient to break the gel that has formed in the heated solution;
f) pasteurizing the high acid and high protein solution to achieve microbial stability; and
g) cooling and then packaging the high acid and high protein solution into a ready-to-drink nutrition beverage.

In another example method of the disclosure, a high acid, high protein nutritional beverage comprising whey protein and collagen is made using the method, comprising:
a) preparing a solution comprising water, food-grade acid in an amount to adjust the pH of the solution to under about 5.5, and optional sweetening agent;
b) adding whey protein into the solution and applying shear to the solution for a sufficient period of time to reduce or minimize formation of whey protein lumps and to incorporate the whey protein into the solution;
c) adding collagen protein into the solution of b) under shear conditions to reduce or minimize formation of lumps for a period of time sufficient to incorporate the collagen into the solution;
d) adjusting the pH of the solution with a pH reducing food-grade acid to a pH below about 5.5 to produce a high acid and high protein solution;
e) heating the high acid and high protein solution above gelling temperature of the whey protein to gel the whey protein and then applying shear sufficient to break the gel that has formed in the heated solution;
f) pasteurizing the high acid and high protein solution to achieve microbial stability; and
g) cooling and then packaging the high acid and high protein solution into a ready-to-drink nutrition beverage.

### Uses for the Nutritional Beverages

The nutritional beverages of the disclosure comprise high concentrations of protein which make them ideal sources for protein supplementation. The high concentration of protein also allows the nutritional beverages to be packaged in small quantities with less liquid. There are significant advantages to producing high protein nutritional beverages with smaller volume footprints, such as for individuals who cannot tolerate consuming traditional sized protein-containing beverages, portability of a smaller size, waste reduction of unconsumed product, ease of storage and transport of smaller quantities.

In one aspect, disclosed are methods of supplementing the nutritional requirements in an individual, comprising administering the high acid and high protein nutritional beverage of the disclosure to the individual in need thereof. The nutritional beverage can be administered orally or by feed-tube.

Individuals in need of nutritional supplementation can be anyone who is looking to increase the amount of their protein intake. The individual can be a healthy individual who is looking to maintain their general wellness, boost their performance and/or recovery during exercise or sports, improving or maintaining muscle mass, muscle strength, joint health, bone health, ligament health, tendon health, prevent loss of muscle mass that occurs in the aging process (e.g., sarcopenia-age-related muscle loss). Athletes, the aging or elderly can all benefit from protein supplementation.

The nutritional beverage is particularly beneficial for the elderly. Protein supplementation may help the elderly in the following ways: fight infections and recover from illnesses more efficiently; tissue repair and recovery from an injury or surgery; maintain stamina and prevent fatigue; reduced nutrition due to changes in taste, dental issues, or medications that suppress hunger; dietary restrictions due to kidney disease, diabetes, heart conditions, digestive disorders and cancer; reduced absorption of protein caused by chronic illness;

The nutritional beverages of the disclosure can benefit individuals with a medical necessity such as, but not limited to individuals undergoing dialysis, having a protein deficiency, cancer prognosis or recovery, decreased appetite, immunocompromised.

Because the nutritional formulations in embodiments comprise collagen protein, they can be used as collagen supplement for any of the traditional reasons for collagen supplementation. Collagen is known for improving or maintaining muscle mass, muscle strength, joint health, bone health, ligament health, tendon health, skin and hair heath.

The nutritional beverages can be administered for wound healing (post-surgical healing, chronic wounds, burn injuries) or to boost the individual's immune system.

Protein supplementation through consumption of the nutritional beverages of the disclosure can aid in weight loss or be consumed in combination with weight loss medications. Advantages of protein supplementation during weight loss include improving or maintaining the skin's elasticity, minimize the effects of weight loss on the individual's appearance and can help tighten loose skin but maintaining or improving muscle health.

The nutritional beverages of the disclosure comprise a high protein content per single serving. The individual in need of protein supplementation will only need to consume a single serving per day to receive the daily recommended amount of protein. The single-serving nutritional beverage can be consumed at one time or as a divided dose. While the ready-to-drink formats of the disclosure are small in liquid volume but high in protein concentration, the volume may be challenging for certain individuals to consume in one daily administration and thus a divided dose may provide the solution.

### Methods of Making High Protein Containing Formulations

In a second aspect, methods of the disclosure can be applied to producing other high protein formulations where there is a need for boosting the protein concentration, but such formulations have heretofore been difficult to achieve due the building of viscosity under high protein concentrations. In general, an acidic solution is prepared, and then a combination of at least two different edible proteins (e.g., a first protein and a second or subsequent protein, such as a third protein, fourth protein, fifth protein, etc.) is added to the solution sequentially or concurrently in high concentrations to produce a high acid and high concentration protein solution. The resulting solution is homogenized, heat sterilized and then packaged. The viscosity of the final solution will have a viscosity that is flowable and below about 300 cps.

According to this aspect, a method of making a high protein formulation having a low viscosity comprises preparing a solution comprising water, food-grade acid and having a pH under 5.5; adding a first edible protein into the solution and applying shear to the solution for a sufficient period of time to reduce or minimize formation of lumping of the first edible protein and to incorporate the first edible protein into the solution; adding a second edible protein into the solution under shear conditions to reduce or minimize formation of protein lumps for a period of time sufficient to incorporate the second edible protein into the solution, wherein the combination of the first edible protein and the second edible protein in the solution is from about 15% by weight to about 50% by weight; adjusting the pH of the solution with a pH reducing food-grade acid to a pH below about 5.5; processing the solution under heat and shear; pasteurizing the high protein solution to achieve microbial stability and a viscosity below about 300 cps and a texture that is non-gelling; and cooling and then packaging the high protein solution into a low viscosity formulation. In embodiments, the formulation will have a smooth texture that is non-gelling.

### Definitions

It is to be understood that the terminology used herein is for describing particular embodiments only and is not intended to be limiting. Unless defined otherwise, all technical and scientific terms used herein have the same meaning as commonly understood by one of ordinary skill in the art to which the disclosure pertains.

Although any methods and materials similar or equivalent to those described herein may be used in the practice for testing of the present disclosure, exemplary materials and methods are described herein.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

As used in this specification and the appended claims, the singular forms “a,” “an,” and “the” include plural referents unless the content clearly dictates otherwise. The conjunctive term “and/or” between multiple recited elements is understood as encompassing both individual and combined options. For instance, where two elements are conjoined by “and/or,” a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options is also understood to fall within the meaning, and therefore satisfy the requirement of the term “and/or.”

Unless the context requires otherwise, throughout the specification and claims that follow, the word “comprise” and synonyms and variants thereof such as “have” and “include”, as well as variations thereof, such as “comprises” and “comprising”, are to be construed in an open, inclusive sense, e.g., “including, but not limited to.” The transitional terms “comprising,” “consisting essentially of,” and “consisting of” are intended to connote their generally accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element or step not specified in the claim; and (iii) “consisting essentially of” limits the scope of a claim to the specified materials or steps “and those that do not materially affect the basic and novel characteristic(s)” of the claimed invention and disclosure. Embodiments described in terms of the phrase “comprising” (or its equivalents) also provide as embodiments those independently described in terms of “consisting of” and “consisting essentially of.”

“About” means within an acceptable error range for the particular value as determined by one of ordinary skill in the art, which will depend in part on how the value is measured or determined, i.e., the limitations of the measurement system. Unless explicitly stated otherwise within the disclosure, claims, result or embodiment, “about” means within one standard deviation per the practice in the art, or can mean a range of ±20%, ±10%, ±5%, +4, ±3, ±2 or ±1% of a given value. It is to be understood that the term “about” can precede any particular value specified herein, except for particular values used in the Examples.

Ready-to-drink (RTD) beverage is defined herein to mean a beverage that is a packaged drink that requires no further preparation before consumption. The ready-to drink beverages of the disclosure are shelf-stable at room temperature and do not require refrigeration before opening. Once opened, unconsumed beverage will need to be refrigerated.

High acid is defined herein to mean a beverage having a pH of 4.6 or lower. This term is consistent with the USDA definition for a food or beverage that can be categorized as “high acid”. For purposes of this disclosure, the pH of the solution can be below about 5.5 and still achieve acceptable viscosity. The categorization of the nutritional beverage as a high-acid beverage is important but it is not the sole consideration for selection of the operative pH for the methods and products of the disclosure.

High protein nutritional beverage is defined herein to mean a nutritional beverage having from about 15% by weight protein to about 50% by weight protein. The protein content in the formulation is provided by a combination of at least two different proteins.

Lecithinated is defined herein to mean any protein used in the formulations of the disclosure that has been treated or modified with lecithin, a group of fatty substances that are naturally found in plant and animal tissues and used as an emulsifier and for other purposes.

Instantized protein is defined herein to mean a protein, such as whey protein, that has been processed to improve its ability to disperse and be solubilized in an aqueous solution, without the protein particles from clumping or aggregating to each other. Known techniques to instantize whey protein are intended to be covered under this definition, including but not limited to fluid bed processing.

Ultra-High Temperature processing or Ultra-Heat Treatment (UHT) is defined herein to mean the processing of the final nutritional beverage under high temperature (e.g., from about 100 °C to about 135 °C) and for a short period of time (e.g., from about 3 seconds to about 10 seconds) to kill bacteria and sterilize the nutritional beverage. The sterilized beverage can then be packaged in aseptic containers under sterile conditions according to manufacturer's specifications and product usage, to produce a read-to-drink nutritional beverage that is storage stable.

Storage stable or shelf stable are defined herein to mean a nutritional beverage of the disclosure that has been packaged under sanitary conditions. The nutritional beverage should be stable (from about 6 months to about 2 years of shelf life) when stored in the original sealed packaging under room temperature (e.g., (e.g., at from about 34 °F (about 1.11 °C) to about 85 °F (about 29.44 °C)). However, after the sealed package has been opened it will ideally be stored at refrigerated temperature (e.g., from about 0 °C to about 5 °C). A combination of ultra-filtration and aseptic packaging achieve shelf-stability of the nutritional beverages of the disclosure.

Individual serving size is intended to mean a nutritional beverage in an appropriate size for an individual to consume in as single dose. For example, the size of the packaged nutritional beverage can be from about 1.0 ounces to 6.0 ounces, and preferably in a ready-to-drink format. Depending on the individual's medical condition, it is understood that the individual may not be able to consume the single dose in one sitting. It should be appreciated that the serving size will be determined by the manufacturer based on manufacturer and customer preferences.

All percents are intended to be weight percent (on a dry weight basis) unless otherwise specified. The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure.

Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

The teachings of all patents, published applications and references cited herein are incorporated by reference in their entirety.

### EXEMPLIFICATION

### Example 1 (Invention). Preparation of Whey/Collagen Protein Drink With 20% Protein Content

1. 78 ml of de-ionized water dispensed into a mixing vessel
2. 0.5 mg Citric acid and 0.8 mg Malic acid dispersed into mixing vessel and mixed well
3. 10 grams Whey Protein Isolate (WPI) mixed into vessel with sufficient shear to break up lumps
4. 10 grams Hydrolyzed Bovine Collagen mixed into vessel with sufficient shear to mix well
5. pH measured at approximately 4.2
6. Flavors and/or sweeteners can be optionally added at this point
7. Mixture heated to 175 °F for 3 minutes to develop flavors and texture
8. Mixture stirred (small amount of shear) and then heated to 200 °F to sterilize
9. Mixture cooled, and stirred aggressively with modest shear Viscosity measured at 65 cps.

The formulation produced according to the process is shown in FIG. 1.

### Example 2—Comparative Example

The process of Example 1 was performed, except step #2 was skipped. No acid was added to the formulation.

During Step 7 (material heated to 175 °F for 3 minutes).

The proteins agglomerated in the mixture, and the resulting formulation resembled cottage cheese. See FIG. 2. The resulting semi-solid mass could not be reduced to a liquid with any amount of shear.

### Example 3—Comparative Example

The process of Example 1 was performed except that the proteins were added first to the vessel and then the acids were added.

During Step 7 (materials heated to 175 °F for 3 minutes). The proteins agglomerated in the mixture, and the resulting material created a thick, pudding/gel like texture with a viscosity over 1200 cps. The resulting pudding could be reduced in viscosity with additional shear, but the final viscosity was too high to be drinkable. (FIG. 3, over 300 cps).

### Example 4 (Invention)—Preparation of Whey/Collagen protein Drink With 35% by Weight Protein Content

The method of Example 1 was performed using 15 grams whey protein and 20 grams collagen to produce a formulation with 35% per weight protein in acidified water. The pH of the resulting solution was about 4.7 and having a viscosity of 170 cps. The resulting formulation was flowable and drinkable and having the viscosity of a thin milk shake. See FIG. 4.

### Example 5 (Invention)—Preparation of Whey/Collagen Protein Drink With 50% by Weight Protein Content

The method of Example 1 was performed using 20 grams whey protein and 30 grams collagen to produce a formulation with 50% per weight protein in acidified water. The pH of the resulting solution was about 4.8 and having a viscosity of 275 cps. The resulting formulation was flowable and drinkable and having the viscosity of a fruit juice. See FIG. 5.

### Example 6 (Invention Versus Comparative)—Preparation of Whey/Optional Collagen Protein Drink With 21% by Weight Protein Content

The method of Example 1 was performed using 20 grams whey protein and optionally 1 gram collagen in acidified water of pH 4.2. The whey formulation without the collagen was a thick sludge that could not be reduced in its viscosity by shear. In contrast, the whey formulation with added collagen resulted in a formulation that was flowable and drinkable with 20% by weight whey and 1% by weight collagen. See FIG. 6A (20% by weight whey protein) and FIG. 6B (20% by weight whey and 1% by weight collagen).

While example embodiments have been particularly shown and described, it will be understood by those skilled in the art that various changes in form and details may be made therein without departing from the scope of the embodiments encompassed by the appended claims.

1. A high acid and high protein nutritional beverage having a low viscosity, comprising:
a high acid solution comprising acidulated water and a combination of at least two different proteins dissolved in the acidulated water, wherein the high acid solution has a pH of from about 2.5 to about 5.5,
the combination of the at least two different proteins is from about 15% by weight to about 50% by weight in the high acid solution, and
the high acid solution having a viscosity about 300 cps or lower and a texture that is non-gelling and can be consumed as a high acid and high protein nutritional beverage.

2. The nutritional beverage of claim 1, wherein the at least two different proteins are a combination of whey protein and collagen protein.

3. The nutritional beverage of claim 2, wherein the whey protein is whey protein isolate, whey protein concentrate, whey protein hydrolysate or combination thereof, and optionally wherein the whey protein is lecithinated and/or instantized.

4. The nutritional beverage of claim 2, wherein the collagen is hydrolyzed collagen.

5. The nutritional beverage of claim 2, wherein the whey protein is from about 1% by weight to about 99% by weight and the collagen is present as the balance of weight percentage.

6. The nutritional beverage of claim 1, wherein the pH is about 4.0 to about 4.6.

7. The nutritional beverage of claim 1, wherein the beverage is provided in a ready-to-drink package in an amount of about 1.0 oz (about 26.57 ml) to about 6.0 oz (about 177.44 ml).

8. The nutritional beverage of claim 1, wherein the beverage is provided in a ready-to-drink package in an amount of about 2 ounces (about 59.15 ml) to about 3 ounces (about 88.72 ml).

9. The nutritional beverage of claim 1, wherein the nutritional beverage is storage stable at room temperature (e.g., at from about 34°F to about 85 °F).

10. The nutritional beverage of claim 1, wherein the viscosity is from about 25 cps to about 200 cps.

11. The nutritional beverage of claim 1, wherein the viscosity is suitable for oral consumption.

12. The nutritional beverage of claim 1, wherein the viscosity is suitable for a feeding tube.

13. The nutritional beverage of claim 1, further comprising one or more amino acids other than amino acids provided by the whey protein and collagen.

14. A method for making the high acid and high protein nutritional beverage with a low viscosity of claim 1, comprising:
a) preparing a solution comprising water, food-grade acid in an amount to adjust the pH of the solution to about 5.5 or lower, and optional sweetening agent;
b) adding a whey protein into the solution and applying shear to the solution for a sufficient period of time to reduce or minimize formation of whey protein lumps and to incorporate the protein into the solution;
c) adding at least a second protein into the solution of b) under shear conditions to reduce or minimize formation of lumps for a period of time sufficient to incorporate the at least a second protein into the solution;
d) adjusting the pH of the solution of b) with a pH reducing food-grade acid to a pH about 5.5 or lower to produce a high acid and high protein solution;
e) heating the high acid and high protein solution above gelling temperature of the whey protein to gel the whey protein and then applying shear sufficient to break the gel that has formed in the heated solution;
f) pasteurizing the high acid and high protein solution to achieve microbial stability; and
g) cooling and then packaging the high acid and high protein solution as a nutritional beverage.

15. The method of claim 14, wherein the at least second protein is collagen, or hydrolyzed collagen.

16. The method of claim 14, wherein the sweetening agent is natural sugar, artificial sugar, Stevia, Monk fruit, high intensity sugar, or a combination thereof.

17. The method of claim 14, wherein the acid in a) is citric acid, malic acid, phosphoric acid and combinations thereof.

18. The method of claim 14, wherein the pH reducing food-grade acid is phosphoric acid.

19. The method of claim 14, further comprising adding an anti-foaming agent to the solution before or after the addition of protein.

20. The method of claim 14, further comprising adding a flavoring agent selected from a fruit flavor, chocolate, vanilla, mocha, coffee and combinations thereof, and/or at least one preservative selected from sodium benzoate, potassium sorbate, culture dextrose products, natural antimicrobial agents and combinations thereof.

21. The method of claim 14, wherein the whey protein is whey protein isolate, whey protein concentrate, whey protein hydrolysate or combination thereof, and optionally wherein the whey protein is lecithinated and/or instantized.

22. The method of claim 14, wherein the viscosity is from about 25 cps to about 200 cps.

23. The method of claim 14, wherein the whey protein is from about 1% by weight to about 99% weight and the second protein is present as the balance of weight percentage.

24. The method of claim 14, wherein the pH is about 4.0 to about 4.6.

25. The method of claim 14, wherein the beverage is provided in a ready-to-drink package in an amount of about 1.0 oz (about 26.57 ml) to about 6.0 oz (about 177.44 ml).

26. The method of claim 14, wherein the nutritional beverage is storage stable at room temperature (e.g., at from about 34 °F to about 85 °F).

27. A method of supplementing nutritional requirements in an individual, comprising administering the high acid and high protein nutritional beverage of claim 1 to the individual in need thereof, wherein the administering is oral or by feed-tube.

28. The method of claim 27, wherein the individual is: (1) an individual is in dialysis, has a protein deficiency, medical necessity, cancer prognosis or recovery, decreased appetite; or (2) an individual in need of improving or maintaining muscle mass, muscle strength, joint health, bone health, ligament health, tendon health.

29. The method of claim 27, wherein the nutritional beverage is administered for wound healing (post-surgical healing, chronic wounds, burn injuries) or to boost the individual's immune system; or the nutritional beverage is administered to the individual to aid in weight loss or in combination with weight loss medications.

30. A method of making a high acid and high protein formulation having a low viscosity, comprising:
a) preparing a solution comprising water, food-grade acid and having a pH under 5.5;
b) adding a first edible protein into the solution and applying shear to the solution for a sufficient period of time to reduce or minimize formation of lumping of the first edible protein and to incorporate the first edible protein into the solution, wherein the first edible protein in the solution is from about 15% by weight to about 50% by weight;
c) adding a second edible protein into the solution of b) under shear conditions to reduce or minimize formation of protein lumps for a period of time sufficient to incorporate the second edible protein into the solution, wherein combination of the first edible protein and the second edible protein in the solution together is from about 15% by weight to about 50% by weight;
d) adjusting the pH of the solution with a pH reducing food-grade acid to a pH about 5.5 or lower;
e) processing the solution under heat and shear;
f) pasteurizing the high protein solution to achieve microbial stability and a viscosity of about 300 cps or lower and a texture that is non-gelling; and
g) cooling and then packaging the high protein formulation having a low viscosity.
